(19) United States
(12) Patent Application Publication
(10) Pub. No.: US 2007/0250406 A1
(43) Pub. Date: Oct. 25, 2007

(54) Interactive product system and related methods

(76) Inventors: Beth Mason, Cincinnati, OH (US); Kara Cain, Cincinnati, OH (US); Hector Ariza, Cincinnati, OH (US); Beth Johnson, Lebanon, OH (US); Alan Kastner, Cincinnati, OH (US); Datina Diego, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/398,836

(22) Filed: Apr. 6, 2006

(51) Int. Cl. G07F 7/00

(52) U.S. Cl. 705/27

(57) ABSTRACT

A method of providing an interactive product system includes selecting a plurality of character images, each character image associated with a unique characteristic selected from a set of unique characteristics, manufacturing a plurality of products, each product having at least one of the character images displayed thereon, and displaying information to a caregiver about at least one of the character images and the unique characteristic that is associated therewith, whereby the caregiver is prompted to interact with a child when the caregiver observes the at least one character images on the product. An interactive product system including the plurality of products and the informational display is also included.

### FIELD OF THE DISCLOSURE

The present disclosure generally relates to an interactive product system and related methods of providing and using the same, and in particular to a product system that facilitates interaction between caregiver and child and related methods.

### BACKGROUND OF THE DISCLOSURE

Studies have recognized the importance of interaction between a caregiver and a child. The interaction between caregiver and child is important for the initial development of such fundamental behaviors as speech and movement. The interaction between caregiver and child may also work in more far-reaching, subtle ways that influence the child's development not only in the early pre-school years, but in the school-age years as well.

It can be difficult, however, to find the time to provide this attention with so many other pressures on a caregiver's time. For example, where the caregiver is in charge of the day-to-day routine of the house, there may be chores to be performed, laundry to be done, etc. Where the caregiver is a wage-earner, time must be spent “at work” (even if the work is performed in the home) as well. Of course, there is also the time that the caregiver spends addressing the basic needs of the child: meals, bath, sleep time, etc. If there is more than one child, addressing these basic needs requires even more time, and the remaining time for each child is further limited as the time available for other activities must be shared among all of the children.

Accordingly, it would be desirable to provide a product or system that facilitates the interaction between caregiver and child. It would be particularly desirable to facilitate the interaction between caregiver and child in a way that the interaction can be combined with other activities during the day.

### SUMMARY

In one aspect, a method of providing an interactive product system includes selecting a plurality of character images, each character image associated with a unique characteristic selected from a set of unique characteristics, manufacturing a plurality of products, each product having at least one of the character images displayed thereon, and displaying information to a caregiver about at least one of the character images and the unique characteristic that is associated therewith, whereby the caregiver is prompted to interact with a child when the caregiver observes the at least one of the character images on the product.

In another aspect, a method of making an interactive product system includes selecting a character image to be associated with one of the senses consisting of sight, hearing, taste, touch and smell, manufacturing a plurality of products, each product having at least one of the character images on each of the products, and displaying information to a caregiver about at least one of the character images and the sense with which it is associated, whereby the caregiver is prompted to interact with a child to stimulate the sense associated with the at least one of the character images when the caregiver observes the at least one character image on the product.

In a further aspect, an interactive product system includes a plurality of products, each product having at least one graphic including at least one character image displayed thereon, each character image associated with one of the senses consisting of sight, hearing, taste, touch and smell, and an informational display associated with the products, the informational display including information about at least one of the character images and the sense with which it is associated.

Additional aspects of the disclosure are defined by the claims of this patent.

### BRIEF DESCRIPTION OF THE DRAWINGS

While the specification concludes with claims particularly pointing out and distinctly claiming the subject matter that is regarded as the present invention, it is believed that the invention will be more fully understood from the following description taken in conjunction with the accompanying drawings. None of the drawings are necessarily to scale.

FIGS. 1-4 are illustrations of graphics including character images and characteristic elements for display on a product or package;

FIG. 5 is an illustration of an informational display;

FIGS. 6 and 7 are illustrations of graphics including character images and story elements for display on a product or package;

FIG. 8 is a perspective view of a product with a graphic including a character image disposed thereon;

FIG. 9 is a perspective view of a package with a character image disposed thereon;

FIG. 10 is an illustration of an informational display on a package;

FIG. 11 is an illustration of an informational display on a webpage; and

FIG. 12 is a flowchart illustrating a method of making or assembling an interactive product system according to the present disclosure.

### DETAILED DESCRIPTION

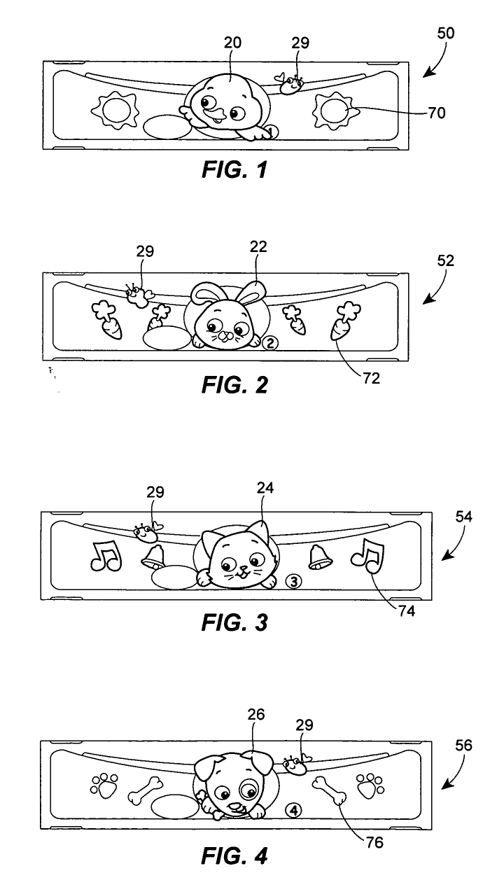

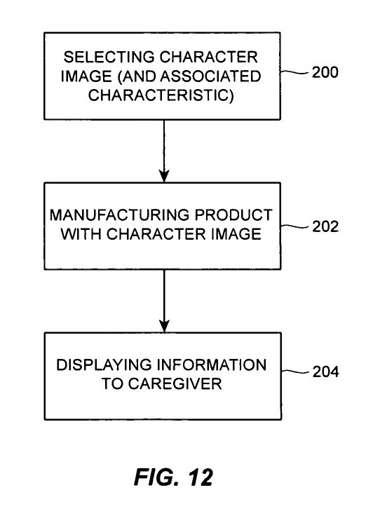

According to the present disclosure, an exemplary interactive product system is illustrated in FIGS. 1-11, along with certain variations thereof, and an exemplary method of providing such a system is illustrated FIG. 12. The system shown herein may facilitate the interaction between a caregiver and a child. That is, a “caregiver” may refer, for example, to a person other than the child, such as, a parent, babysitter, family member, teacher, day care worker, or other person who is able to provide sufficient assistance to the child to complete a personal hygiene task, while a “child” may refer, for example, to a baby, infant, or toddler.

Turning first to FIGS. 1-7, FIGS. 1-7 illustrate a first aspect of an interactive product system according to the present disclosure: a graphic that may include a character image, characteristic elements and/or story elements.

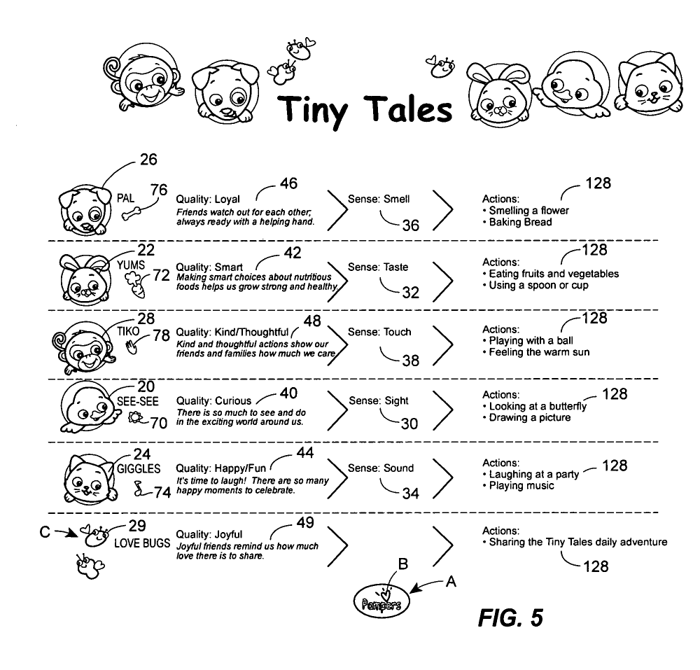

FIGS. 14 illustrate a series of character images 20, 22, 24, 26, with two additional character images 28, 29 also shown in FIG. 5. A “character image” may refer to a graphic containing an anthropomorphic image. According to certain embodiments, the image may have or suggest human form or appearance which ascribes human motivations, characteristics or behavior to inanimate objects, animals, natural phenomena, toys, cartoon characters, or the like. According to the embodiment illustrated in FIGS. 1-5, each character image 20, 22, 24, 26, 28 is of an animal, with the character image 20 being a duck, the character image 22 being a rabbit, the character image 24 being a cat, the character image 26 being a dog, and the character image 28 being a monkey.

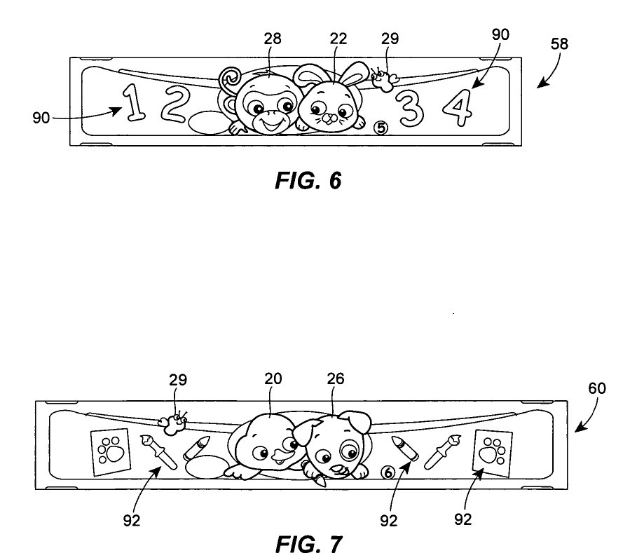

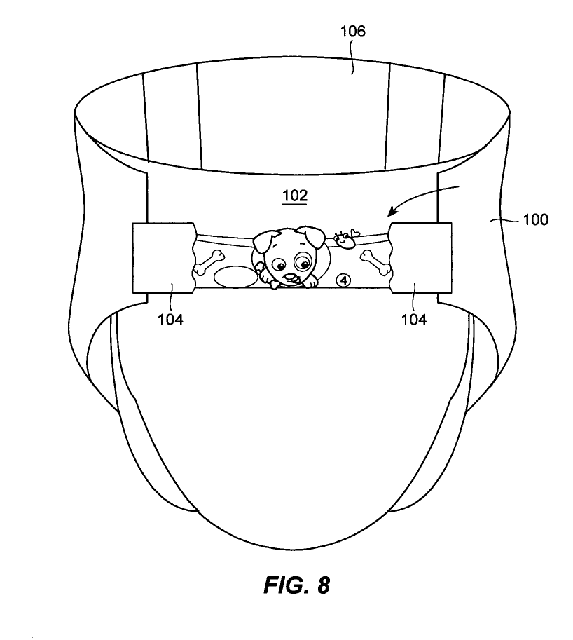

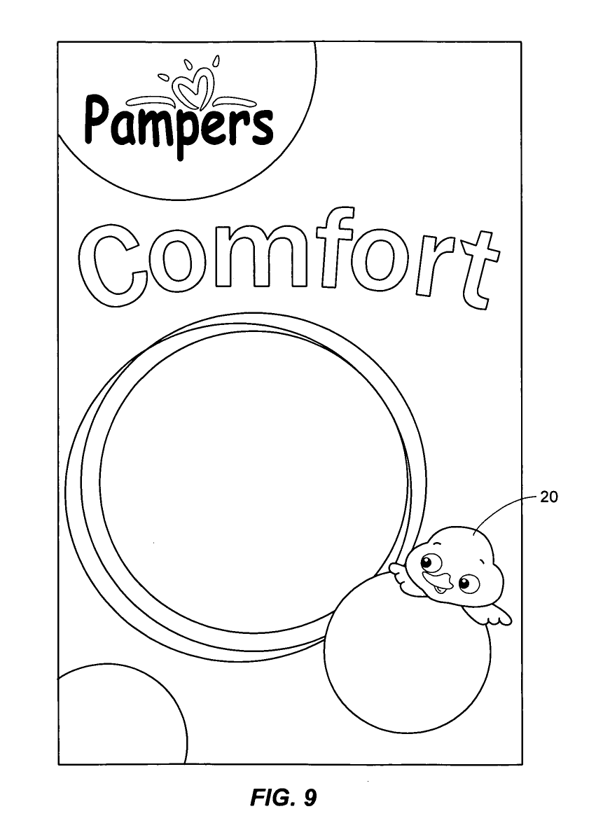

A character image 29 is also provided, the character image 29 including two insects, referred to in FIG. 5 as “love bugs”. Given that two “love bugs” are included in this character image, it will be recognized that a character image need not be limited to a single entity, but may be formed from a collection of entities, in this case two “love bugs”. This is to be contrasted with FIGS. 6 and 7, referred to below, where separate character images are combined in a single graphic. It will also be recognized that the “love bugs” could be separated from each other while still be referred to as a single character image.

The character image 29 is also different from the images 20, 22, 24, 26, 28 in another way: the image 29 has incorporated therein brand information regarding a company that is associated (e.g., as manufacturer of) the product on which the image 29 will appear. Specifically, it is noted that brand information A is provided in FIG. 5 in the form of a logo incorporating graphic elements. In particular, it will be recognized that the brand information A includes a heart-shaped element B. It will be further recognized that the character image 29 includes “wings” C that are shaped in the form of the heart-shaped element B. After this fashion, the character images 29 may include not only design elements that assist in defining the character, but that convey other information as well.

Each character image 20, 22, 24, 26, 28 has at least one unique characteristic associated therewith. That is, each character image is associated with a particular trait, experience, attribute, skill, etc. that is different from the traits, experiences, attributes, skills, etc. associated with the other character images. The different characteristics may be recognized opposites of each other, such as “night” and “day”, or “hot” and “cold”. However, the characteristics need not be opposites to be different, and thus unique, such as in the example wherein the characteristics are “red”, “yellow” and “blue”.

According to one embodiment, each unique characteristic is selected from a group or a set of characteristics. The example provided above, wherein each characteristic is selected from the group of primary colors, could define one such group. A further example may be defined by the elements: “earth”, “air”, “fire” and “water”. Another group may be defined by the parts of the face: “eyes”, “ears”, “nose”, “mouth”, and “chin”. Still another group may be defined by a set of virtues: “courage”, “curiosity”, “generosity”, “love” and “strength”. As will be recognized, these groups or sets could include all members of a widely-recognized group or set, such as in the example of the primary colors or the elements, although that need not be the case in every embodiment. Moreover, it is within the scope of this disclosure to form a group or set of items not generally recognized as forming a group, such as “up”, “down”, “light” and “dark”.

According to the particular embodiment illustrated, as seen in FIG. 5, each character image 20, 22, 24, 26, 28 is associated with a particular sense: “sight” 30, “taste” 32, “sound” 34, “smell” 36, “touch” 38. Specifically, the duck 20 may be associated with the sense of sight 30. The rabbit 22 may be associated with the sense of taste 32. The cat 24 may be associated with the sense of sound 34. The dog 26 may be associated with the sense of smell 36. The monkey 28 may be associated with the sense of touch 28.

Furthermore, according to the illustrated embodiment, each character image 20, 22, 24, 26, 28 may also be associated with a quality selected from the set of qualities including: “curious”, “smart”, “happy/fun”, “loyal”, and “kind/thoughtful”. Specifically, the duck 20 may be associated with curiosity 40. The rabbit 22 may be associated with smarts or intellect 42. The cat 24 may be associated with happiness and fun 44. The dog 26 may be associated with loyalty 46. The monkey 28 may be associated with kindness or thoughtfulness 28.

Thus, each of the character images 20, 22, 24, 26, 28 is illustrated as having two characteristics associated therewith. By contrast, the character image 29 is not associated with a sense, but is associated with a quality: Joy 49. It should thus be understood that it is not necessary for every character image to have a unique characteristic relative to all other character images for every set of characteristics used. In fact, it may be possible for certain character images to only have unique characteristics associated with a first group or set, certain other character images to only have unique characteristics associated with a second group or set, and still further character images to have unique characteristics selected from the first set and the second set, and all of these character images to appear in a single graphic or series of graphics with each other.

Thus, returning to FIGS. 1-4, it will be seen that each graphic 50, 52, 54, 56 includes at least one of the character images 20, 22, 24, 26 and at least one character image 29. Thus, these graphics 50, 52, 54, 56 represent configurations, in the form of combinations, of more than one character image. It will be recognized that only one character image may be used in a particular graphic, while FIGS. 6 and 7 illustrate that more than two character images may be used in a single graphic. In particular, FIG. 6 illustrates a graphic 58 including a combination of the monkey 28, the rabbit 22, and the love bug 29, while FIG. 7 illustrates a graph 60 including a combination of the duck 20, the dog 26, and the love bug 29.

It will also be recognized that the graphics 50, 52, 54, 56, 58, 60 in FIGS. 1-4, 6 and 7 include graphic elements other than the character images 20, 22, 24, 26, 28, 29. The specific graphic elements illustrated may be referred to as characteristic elements and story elements, for example.

That is, taking FIG. 1 as an example, the graphic 50 includes graphic elements 70 in the form of a sun. The sun 70 may appear elsewhere, for example in FIG. 5, and may serve as a visual reminder of a unique characteristic associated with the character image. In this instance, the sun 70 may serve as a visual reminder that the sense associated with the duck 20 is the sense of sight 30. Elsewhere in FIGS. 2-4 are illustrated carrots 72, musical notes 74, and bones 76, which may serve as characteristic elements for the rabbit 22 (taste 32), cat 24 (hearing 34), and dog 26 (smell 36), respectively. The relation of some of these characteristic elements may be immediately apparent to the viewer (e.g., the musical notes 74 and the sense or hearing 34); while others may be less apparent (e.g., the bone 76 and the sense of smell 36).

Referring now to FIGS. 6 and 7, the graphic 58 includes story elements 90 in the form of numbers, while the graphic 60 includes story elements 92 in the form of crayons, paint brushes and drawings. These story elements 90, 92 may not appear elsewhere in association with any of the character images 20, 22, 24, 26, 28, 29 illustrated in the graphics 58, 60, and may not be intended to serve as a visual reminder as to the characteristics associated with the character images. However, the story elements may be used as a visual cue for a story or storyline that could include the character images 20, 22, 26, 28, 29 as the actors, and in which, for example, the character images 20, 22, 26, 28, 29 use their unique characteristics.

For example, referring to the graphic 58 in FIG. 6, a story could be assembled from the images and elements as follows. Using the monkey 28 and the story elements 90, the story could begin with the monkey 28 having four bananas: “1”, “2”, “3” and “4”. Using the rabbit 22 and her sense “taste” 32, the rabbit 22 could be hungry, and could meet her friend monkey 28 returning from the market with his four bananas. Given the monkey's quality, “kind/thoughtful” 48, and the presence of the love bug 29, the story could continue with the monkey 28 offering to share his bananas with the rabbit 22. The rabbit 22 could then use her quality, “smart” 42, to offer to divide the bananas equally between the two friends: “1” and “2” bananas for monkey 28 and “3” and “4” bananas for rabbit 22. The story could conclude with the two friends 22, 28 and the love bugs 29 agreeing that sharing between friends always was best.

This visual style of story telling may be particularly useful with children who are pre-literate. The terms “pre-literate” and “incapable of reading” are used interchangeably herein to refer to the inability of a child to correctly understand, comprehend and follow prompts written in a language that the child can speak without assistance of a caregiver. The ability of a child to recognize letters and/or read one or two isolated words still means that the child is “incapable of reading” since he or she is unable to understand, comprehend and follow such written prompts, without assistance. However, this definition of “incapable of reading” does not exclude the child from being able to understand, comprehend and follow visual prompts which are presented in the form of drawings, icons, symbols, gestures, cartoons and the like.

Turning now to FIGS. 8 and 9, a second aspect of the interactive product system is illustrated: the product, on which the first aspect of the system, the graphic, is displayed, and which may be used by a caregiver during the daily routine of caring for a child.

The product 100 illustrated is an “absorbent article”: i.e., a device that absorbs and contains liquid, and more specifically, refers to a device that is placed against or in proximity to the body of the wearer to absorb and contain the various exudates discharged from the body. In particular, the absorbent article may be a “diaper” (i.e., an absorbent article generally worn by infants and incontinent persons about the lower torso and having the general form of a sheet, different portions of which are fastened together to encircle the waist and the legs of the wearer), although it could be “training pants” (i.e., an absorbent article generally worn by infants and incontinent persons about the lower torso and having the general form of a pair of short pants that can be applied or removed from the wearer without unfastening) according to other embodiments.

Also as illustrated, the graphic 56 may be disposed on a portion of the product 100, referred to as the landing zone 102, where the fasteners 104 attach to form the waist 106 of the diaper 100. According to other embodiments, the graphic 56 may be disposed elsewhere on the diaper 100, for example, at a location lower than the landing zone 102. The graphic 56 may even be disposed on the rear of the diaper 100, because the graphic 56 need not be visible to the child or caregiver during use of the diaper 100.

The placement of the graphic (e.g., 56) on the product 100 is intended to facilitate interaction of the caregiver and the child in the following manner, for example. The changing of a child's diaper by a caregiver is an activity which (i) occurs multiple times each day, (ii) involves both the caregiver and the child, requiring both to be present at the same location and during the same time, and (iii) typically cannot be performed while either the caregiver or the child undertakes another activity. Thus, diaper changing provides a significant untapped opportunity for the child and the caregiver to interact, given that neither the child nor the caregiver can be elsewhere or doing something else and the activity occurs many times each day. The placement of the graphic on the product 100 may capitalize on this opportunity by providing the caregiver with a rudimentary outline of a story that can be developed by the caregiver to, for example, entertain and/or instruct. Using the embodiment illustrated in FIGS. 1-7, the caregiver, following the visual cues or prompts embodied in the character images, characteristic elements, and story elements, may build a story or perform an activity involving the characters and their respective senses. The specific placement is thus not important to all embodiments of the system and method, given that the cues may be supplied to the caregiver equally well if the graphic is on a part of the product 100 that is visible to the child during its use by the child, or if the graphic is not.

In fact, the product 100 may be used by the caregiver as a form of pseudo-book, pamphlet or worksheet. That is, again referring to the embodiment wherein the product 100 is a diaper or training pant, the caregiver may provide the child with a first diaper 100 while the caregiver proceeds to use a second diaper 100 to replace a diaper that the child has soiled. The caregiver may then refer to the graphic applied to the first diaper 100 in developing a story or performing an activity with the child, while using the second diaper 100 in its typically intended role as an absorbent article. The caregiver's use of the diapers 100 in this fashion may be further facilitated in those embodiments of the method and system where every product in a package has a different character image displayed on it, although embodiments wherein not every product has an image displayed or where every product has the same image displayed may also be beneficial. In those embodiments where not every product has an image, it may be beneficial to only have certain products for use as pseudo-books, while the remainder are fully useable for their originally intended purpose. In those embodiments where every product has the same image, the caregiver and the child may benefit from the reinforcement of a single concept (e.g., sense).

The graphic may be visible (i.e., the quality of being capable of being seen by the naked eye under conditions of normal room lighting or in natural light during the daytime) before and after use (e.g., after an insult of urine). According to other embodiments, the graphic may become less visible (i.e., changing in visibility to a noticeable extent when viewed under a generally constant or equal lighting condition) when wetted. Alternatively, the graphic may change color when wetted. The variation in the visibility or color of the graphic may be created by the use of inks or dyes or other agents that undergo chemical reactions or are dispersed or concentrated when wetted by urine, for example. Other variations will be recognized, as will be the mechanism for bringing about the change. After this fashion, the graphic may be multi-functional—useful at least both as part of the interactive product system described herein and as a wetness sensation member.

While the product 100 is illustrated as a diaper according to the exemplary embodiment, the product 100 may, in fact, be any product used or useable by a caregiver and/or a child. For example, the product 100 could be a disposable washcloth, disposable wipe, etc. Nor does the product necessarily have to be disposable; it could be a terry-cloth washcloth or towel, or even an item of children's clothing. Further, the graphic need not be displayed only on the product 100, but may be displayed on the packing (as illustrated in FIG. 9) as well as or instead of on the product 100.

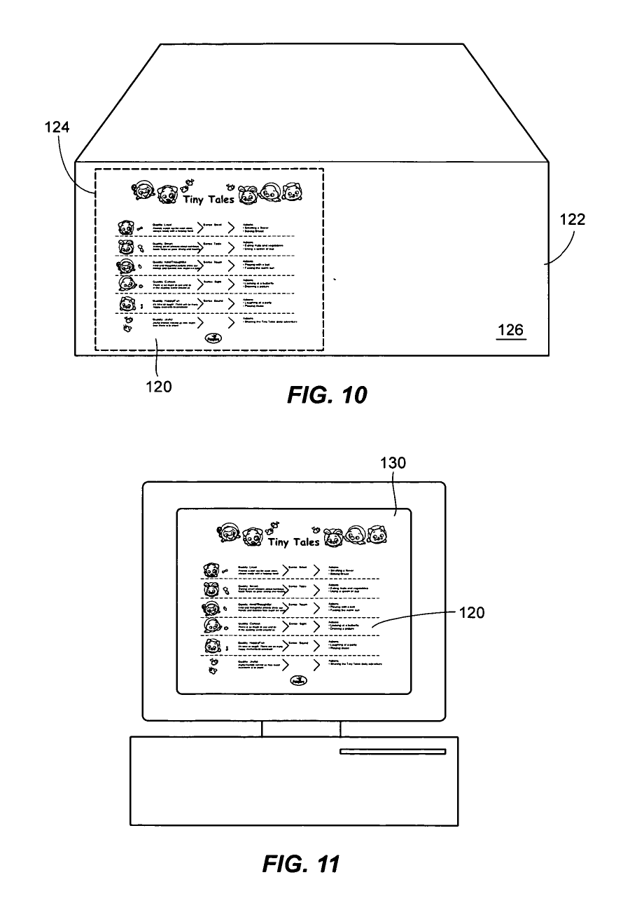

Turning now to FIGS. 10 and 11, a third aspect of an interactive product system is illustrated: an informational display.

FIG. 10 illustrates a first informational display 120, as may appear on a package 122. In particular, the information display 120 may be similar to that shown in FIG. 5, and may be displayed on a portion 124 of one surface 126 of the package 122. The information display 120 may include information about the character images 20, 22, 24, 26, 28, 29 and the associated characteristics 30, 32, 34, 36, 38, 40, 42, 44, 46, 48, 49, although where, as here, certain images 20, 22, 24, 26, 28 are associated with characteristics from more than one group or set, information about only one set may be included. In addition to the information on the images and characteristics, the information display may include information, as is shown in FIG. 5, about the characteristic elements 70, 72, 74, 76, 78 associated with certain of the character images 20, 22, 24, 26, 28. Still further, again with reference to FIG. 5, the informational display may include tips, suggestions, etc. 128 for actions that the character images 20, 22, 24, 26, 28, 29 might take during a story formed by the associated of character images, characteristic elements and story elements.

The display of such information need not be only on a package 122, as is illustrated in FIG. 10. The information may be displayed on an information insert that is included in or with the package 122. Alternatively, the informational display 120 may be included on information that is sent to the caregiver as part of a program which the caregiver signs up for, for example, by mail, like a club. As still another alternative, the information display 120 may be included in advertising materials that are mailed to the caregiver, appear in a circular available at a retail establishment, appear on a point-of-purchase display or the like. As a further example, as shown in FIG. 11, the information display 120 may be displayed on a webpage 130 which is provide as part of a website provided by the manufacturer of the product 120. According to still other embodiments, the information may appear on the product, along with the graphic.

Having thus described the aspects of the interactive product system, a method of providing such a system is now explained with reference to FIG. 12.

The method begins at block 200, wherein a plurality of character images is selected. This selection may be performed by a manufacturer of children's products. As another alternative the selection may be performed by party working on behalf of the manufacturer, such as a design firm, the actions of the design firm being attributable to the manufacturer in such a setting. As another alternative, the selection may be performed by a company in the business of selling children's products, which company then acts in concert with a manufacturer to have the products manufactured.

As noted above, each of the character images selected is associated with a unique characteristic selected from a set of unique characteristics. As was the case with the selection of the character images, the selection of the set of characteristics and the association of the characteristics with the character images may be performed by the manufacturer. Alternatively, a third party, such as a design firm or retailer/wholesaler, which works with a manufacturer, may select the set of characteristics and the associate the characteristics with the images. In fact, the selection of the character images and the selection and association of the characteristics may occur at the same time or at different times.

The method then proceeds to block 202, where products are manufactured, the products having at least one of the character images displayed thereon. As explained above relative to the selection of the images, the manufacturer need not be the party that selects the images to be displayed on the product, although the manufacturer may well perform this step as well. Moreover, as explained above relative in reference to the system, according to the illustrated embodiment, the graphic including a character image is disposed on a diaper product, but neither the system nor the method is limited to the manufacture of diapers, but may include other products as well.

The method then proceeds to block 204, where information is displayed to the caregiver about the at least one character image and the unique characteristic that is associated therewith. As noted above relative to the system, there exists a wide variety of methods for displaying the information regarding the character images and their characteristics. The information may be displayed on the packaging, on point-of-purchase displays, in advertising circulars or mailers, or over the Internet. As was the case with the preceding step, these activities may be undertaken by the manufacturer or by a party at the manufacturer's request, or by a party acting in concert with the manufacturer or for whom the manufacturer manufactured the product.

Therefore, according to one embodiment of the interactive product system described above, a manufacturer of children's goods may select a set of five character images 20, 22, 24, 26, 28, each of which is associated with one of the senses (e.g., sight 30, taste 32, hearing 34, smell 36, and touch 38). The manufacturer may also develop a plurality of characteristic elements 70, 72, 74, 76, 78 and story elements 90, 92 to be used in association with the character images 20, 22, 24, 26, 28 to represent the sense 30, 32, 34, 36, 38 associated with each of the character images 20, 22, 24, 26, 28, and to facilitate development of stories or activities involving the characters and/or the senses associated with the characters. The manufacturer may further decide to make a diaper product 100 wherein the character images 20, 22, 24, 26, 28, characteristic elements 70, 72, 74, 76, 78, and story elements 90, 92 are displayed in a graphic disposed on the product 100.

The manufacturer may fabricate hundreds of diapers 100, each bearing a graphic including at least one of the character images 20, 22, 24, 26, 28 and some subset of characteristic elements 70, 72, 74, 76, 78 and story elements 90, 92 selected from the entire set. For example, the manufacturer may select a limited series of graphics incorporating character images 20, 22, 24, 26, 28, characteristic elements 70, 72, 74, 76, 78 and story elements 90, 92 to allow mass production of the product 100 while providing sufficient variation in the graphics included to limit “staleness” in the presentation to the caregiver if a large number of the products 100 are packaged and sold together as a group. The manufacturer may then assemble the diapers 100 into packages 122, each package 122 including a predetermined number of diapers 100.

The manufacturer may also provide an informational display 120 on the package 122, such as is shown in FIG. 10. The informational display 120 disposed on a surface 126 of the package 122 may include a limited amount of information about the character images 20, 22, 24, 26, 28, characteristics 30, 32, 34, 36, 38, etc., while referring the caregiver to a website 130 (see FIG. 11) where additional information, or information of greater detail, may be provided. Alternatively, the manufacturer may include an insert in the package 122 with a greater detail of information that can be found on the package 122. The insert may even be in the form of a story book that utilizes the character images 20, 22, 24, 26, 28, characteristic elements 70, 72, 74, 76, 78 and story elements 90, 92 to be found in the graphics, and develops their meanings through narrative prose instead of through the inclusion of definitional statements.

The caregiver purchases a package 122 of the specially-designed diapers 100, or receives them through another channel. The caregiver can then read the information display 120 on the package 122 to discover the meanings attached to and associations between the character images 20, 22, 24, 26, 28 and the characteristic elements 70, 72, 74, 76, 78. The caregiver may reinforce his or her knowledge of these meanings or associations through viewing additional materials provided by the manufacturer, such as in the form of a webpage 130 or product insert. Alternatively, the caregiver may learn about the meanings and associations as she or he uses the graphics to interact with the child.

In use, the caregiver may, at diaper-changing time, use one of the diapers 100, while providing another diaper 100 to the infant. The caregiver may then use the knowledge from the informational display 120 to develop an activity or story from the graphic disposed on the diaper 100 that he or she provided to the infant. For example, if the diaper 100 handed to the infant had the graphic 54, shown in FIG. 3, disposed thereon, the caregiver might explain that “Giggles” is a cat, that cat's have good hearing, and that “Giggles” likes to hear music. The caregiver might then sing a little song to the infant. Alternatively, if the diaper 100 had the graphic 50, shown in FIG. 1, disposed thereon, the caregiver might explain that “See-See” is a duck, and that “See-See” is a curious duck—always exploring the world around her. The caregiver might then play “peek-a-boo” with the child.

Thus, in this fashion, the product 100 may facilitate an interaction between the caregiver and the child. This interaction may be beneficial both the caregiver and the child. The caregiver is provided additional opportunities to nurture the child's development and is given the tools to assist the caregiver in this activity. The child is provided with additional opportunities to receive additional instruction and attention from the caregiver, fostering development.

All documents cited in the Detailed Description are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of providing an interactive product system, the method comprising:
selecting a plurality of character images, each character image associated with a unique characteristic selected from a set of unique characteristics;
manufacturing a plurality of products, each product having at least one of the character images displayed thereon;
displaying information to a caregiver about at least one of the character images and the unique characteristic that is associated therewith,
whereby the caregiver is prompted to interact with a child when the caregiver observes the at least one of the character images on the product.

2. The method of claim 1, comprising:
disposing the plurality of products in a package; and
displaying information to a caregiver about the at least one character image and the unique characteristic that is associated therewith on the package.

3. The method of claim 1, comprising:
displaying information to caregiver about the at least one character image and the unique characteristic that is associated therewith on a website.

4. The method of claim 1, wherein the plurality of products comprises a plurality of disposable absorbent articles having a waist portion, and comprising:
displaying the at least one character image on each of the disposable absorbent articles at the waist portion thereof.

5. A method of making an interactive product system, the method comprising:
selecting a character image to be associated with one of the senses consisting of sight, hearing, taste, touch and smell;
manufacturing a plurality of products, each product having at least one of the character images on each of the products; and
displaying information to a caregiver about at least one of the character images and the sense with which it is associated,
whereby the caregiver is prompted to interact with a child to stimulate the sense associated with the at least one of the character images when the caregiver observes the at least one character image on the product.

6. The method of claim 5, comprising:
disposing the plurality of products in a package; and
displaying information to a caregiver about the at least one of the character images and the sense with which it is associated on the package.

7. The method of claim 5, comprising:
displaying information to a caregiver about the at least one of the character images and the sense with which it is associated on a website.

8. The method of claim 5, wherein the plurality of products comprises a plurality of disposable absorbent articles having a waist portion, and comprising:
displaying at least one character image on each of the disposable absorbent articles at the waist portion thereof.

9. An interactive product system comprising:
a plurality of products, each product having at least one graphic including at least one character image displayed thereon, each character image associated with one of the senses consisting of sight, hearing, taste, touch and smell; and
an informational display associated with the products, the informational display including information about at least one of the character images and the sense with which it is associated.

10. The interactive product system according to claim 9, wherein the at least one graphic comprises a characteristic element associated with the sense associated with the at least one character image that is included in the graphic.

11. The interactive product system according to claim 9, wherein the at least one graphic comprises a story element.

12. The interactive product system according to claim 9, wherein the at least one character image comprises brand information integrated therein.

13. The interactive product system according to claim 9, wherein:
the products comprise disposable absorbent articles, each having a waist portion; and
the at least one graphic is displayed at the waist portion of the disposable absorbent articles.

14. The interactive product system according to claim 9, wherein:
the products are disposed in a package; and
the information display is disposed on the package.

15. The interactive product system according to claim 9, wherein the information display is included in a webpage.
